(19) United States
(12) Patent Application Publication
(10) Pub. No.: US 2024/0412060 A1
(43) Pub. Date: Dec. 12, 2024

(54) TRAINING AND OPERATING NEURAL NETWORK BASED RANKING MODEL

(71) Applicant: City University of Hong Kong, Kowloon (HK)

(72) Inventors: Sichun Luo, Kowloon (HK); Linqi Song, Kowloon (HK)

(21) Appl. No.: 18/330,541

(22) Filed: Jun. 7, 2023

(51) Int. Cl. G06N 3/08

(52) U.S. Cl. CPC G06N 3/08

(57) ABSTRACT

A computer-implemented method for training a neural network based ranking model includes performing a training data augmentation operation on a set of training data to generate a set of synthesized training data, and training a neural network based ranking model using the set of training data and the set of synthesized training data. The set of training data includes, for each of a plurality of queries, respective query-document data and respective relevance judgement data. The query-document data for a query includes data associated with a plurality of query-documents pairs for the query. The relevance judgement data for a query includes one or more sets of user feedback data associated with the query. The set of training data has an imbalanced training data distribution and the set of synthesized training data is arranged for use to reduce training data distribution imbalance of the set of training data.

### TECHNICAL FIELD

The invention generally relates to training and operation of a neural network based ranking model.

### BACKGROUND

Learning to Rank (LTR), or machine-learned ranking (MLR), is the application of machine learning techniques for generating ranking models for information systems. Different ranking models may be generated for different applications. The performance (e.g., accuracy, fairness, etc.) of these ranking models may depend on, among other things, the training data and the training process.

### SUMMARY OF THE INVENTION

In a first aspect, there is provided a computer-implemented method for training a neural network based ranking model. The computer-implemented method comprises:

performing a training data augmentation operation on a set of training data to generate a set of synthesized training data, and training a neural network based ranking model using the set of training data and the set of synthesized training data. The set of training data comprises, for each of a plurality of queries, respective query-document data and respective relevance judgement data. The query-document data for a query comprises data associated with a plurality of query-documents pairs for the query. The relevance judgement data for a query comprises one or more sets of user feedback (e.g., user click) data associated with the query. The set of training data has an imbalanced training data distribution such that amounts of relevance judgement data available for at least some the plurality of queries are different, and the set of synthesized training data is arranged for use to reduce training data distribution imbalance of the set of training data.

Optionally, the imbalanced training data distribution generally follows a long-tail distribution or heavy-tail distribution.

Optionally, the training data augmentation operation comprises: (i) for each of the plurality of queries, determining a respective representation of the query; (ii) for each of the plurality of queries, determining one or more respective neighbor queries based on the determined representations of the plurality of queries; and (iii) for one or more of the plurality of queries, generating synthesized training data based on relevance judgement data associated with the query and relevance judgement data associated with one or more of the neighbor queries of the query.

Optionally, each of the plurality of queries respectively corresponds to a plurality of query-document pairs with corresponding features; and the determining of the respective representation of the query is based on the corresponding features of the query.

Optionally, the determining of the respective representation of the query is based on a statistical measure of the corresponding features of the query.

Optionally, the determining of the respective representation of the query is based on a mean of the corresponding features of the query.

Optionally, the determining of the one or more respective neighbor queries is based on k-nearest-neighbor (KNN) method.

Optionally, the generating of synthesized training data for a query comprises: (a) sampling, from a plurality of sets of user feedback data associated with the query, one set of user feedback data associated with the query to obtain a first data sample; (b) selecting one of the neighbor queries associated with the query, and sampling, from a plurality of sets of user feedback data associated with the selected neighbor query, one set of user feedback data associated with the selected neighbor query to obtain a second data sample; and (c) synthesizing a data sample based on the first data sample and the second data sample. In some embodiments, the sampling in (a) may be random. In some embodiments, the selection in (b) may be random. In some embodiments, the sampling in (b) may be random.

Optionally, the synthesizing of the data sample is based on:

$${l}^{′} = λ {l}_{{q}_{i}} + ( 1 - λ ) {l}_{{q}_{j}}$$

where l′ is the synthesized data sample, l_{qi} is the first data sample, l_{qj} is the second data sample, and λ is a hyper-parameter. Preferably, 0<λ<1.

Optionally, the generating of synthesized training data for one or more of the plurality of queries respectively further comprises: repeating steps (a) to (c) to synthesize multiple data samples.

Optionally, the number of repeat of steps (a) to (c) for each respective one of the queries is dependent on (adaptive to) an amount of user feedback data associated with the query.

Optionally, the computer-implemented method further comprises: determining, based on the relevance judgement data for the plurality of the queries, frequency of occurrence or relative frequency of occurrence of each of the plurality of queries. Optionally, the number of repeat of steps (a) to (c) for each respective one of the queries is dependent on the determined frequency of occurrence or relative frequency of occurrence of the corresponding query.

Optionally, the relative frequency of occurrence of a query is determined based on:

$${T}_{{q}_{i}} = log ( {t}_{i} + 1 )$$

where T_{qi} corresponds to a tailness measure of the query, and tᵢ is a number of sets of user feedback data for the query.

Optionally, the number of repeat of steps (a) to (c) for each respective one of the queries is associated with a weighting factor wᵢ defined as:

$${w}_{i} = max ( \frac{{T}_{max} - {T}_{i}}{{T}_{max} - {T}_{min}} \cdot {w}_{e} , {w}_{c} )$$

where wₑ is a hyper-parameter that controls an overall weight of synthesizing data samples, Tₘₐₓ and Tₘᵢₙ are maximum and minimum values of T respectively, and w_{c} is a threshold value.

Optionally, the neural network based ranking model comprises: a first model branch with a first multilayer perceptron and a first predictor operably coupled with the first multilayer perceptron; a second model branch with a second multilayer perceptron and a second predictor operably coupled with the second multilayer perceptron; and a combiner for combining an output of the first predictor and an output of the second predictor. The first multilayer perceptron and the second multilayer perceptron may have the same model architecture/structure. The first predictor and the second predictor may have the same architecture/structure.

Optionally, the combiner is arranged to apply a weighting to the output of the first predictor and/or a weighting to the output of the second predictor.

Optionally, the training of the neural network based ranking model comprises: performing a ranking or scoring operation based on the set of training data and the set of synthesized training data using the neural network based ranking model.

Optionally, the ranking or scoring operation comprises: processing the set of training data with the first model branch; and processing a combination of the set of training data and the set of synthesized training data with the second model branch.

Optionally, the computer-implemented method further comprises: determining ranking or scoring loss [symbol] based on the performing of the ranking or scoring operation.

Optionally, the training of the neural network based ranking model further comprises: performing a contrastive learning operation based on the set of training data and/or the set of synthesized training data using the neural network based ranking model.

Optionally, the contrastive learning operation comprises: for one or more of the queries: for data associated with each of the plurality of query-documents pairs of the query, performing a data perturbation operation to generate respective augmented data for the data of each of the plurality of query-documents pairs; and processing the augmented data using the neural network based ranking model.

Optionally, the data perturbation operation comprises: generating, for each of the data of each of the plurality of query-documents pairs: a first set of augmented data with a first extent of noise injection; and a second set of augmented data with a second extent of noise injection different from the first extent.

Optionally, the neural network based ranking model further comprises: a first projector operably coupled with the first multilayer perceptron and a second projector operably coupled with the second multilayer perceptron. Optionally, the contrastive learning operation further comprises: processing the augmented data (e.g., both the first and second sets of augmented data) using the first multilayer perceptron and the first projector; and processing the augmented data e.g., both the first and second sets of augmented data) using the second multilayer perceptron and the second projector.

Optionally, the computer-implemented method further comprises: determining a contrastive loss [symbol] based on the performing of the contrastive learning operation.

Optionally, the computer-implemented method further comprises: performing a joint optimization operation based on the performing of the ranking or scoring operation and the performing of the contrastive learning operation.

Optionally, the joint optimization operation comprises: jointly optimizing a ranking or scoring loss [symbol] associated with the performing of the ranking or scoring operation and the contrastive loss [symbol] associated with the performing of the contrastive learning operation.

Optionally, the jointly optimizing comprises: optimizing an overall loss [symbol] that equals to [symbol] +γ [symbol] , where γ is hyper-parameter.

In a second aspect, there is provided a system for training a neural network based ranking model, comprising: one or more processors, and memory storing one or more programs configured to be executed by the one or more processors, the one or more programs including instructions for performing or facilitating performing of to the computer-implemented method of the first aspect.

In a third aspect, there is provided a non-transitory computer-readable storage medium storing one or more programs configured to be executed by one or more processors, the one or more programs including instructions for performing or facilitating performing of to the computer-implemented method of the first aspect.

In a fourth aspect, there is provided a computer-implemented method for operating a neural network based ranking model, comprising: processing a query and a set of document data (data associated with a plurality of documents) using the neural network based ranking model trained using the computer-implemented method of the first aspect to determine a result. Optionally, the computer-implemented method further comprises presenting (e.g., displaying) the result. The result may include a ranked or ordered list of documents.

In a fifth aspect, there is provided a system for training a neural network based ranking model, comprising: one or more processors, and memory storing one or more programs configured to be executed by the one or more processors, the one or more programs including instructions for performing or facilitating performing of to the computer-implemented method of the fourth aspect.

In a sixth aspect, there is provided a non-transitory computer-readable storage medium storing one or more programs configured to be executed by one or more processors, the one or more programs including instructions for performing or facilitating performing of to the computer-implemented method of the fourth aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

As used herein, unless otherwise specified, the term “document” is used generally to refer to any item of information such as digital image, photograph, electronic document or file, email message, voice mail message, short message service message, web page, part of a web page, map, electronic link, commercial product, multimedia file, song, book, album, article, database record, a summary of any one or more of these items, etc. Such information be retrieved using or by a query server (e.g., search engine).

Terms of degree such that “generally”, “about”, “substantially”, or the like, are used, depending on context, to account for manufacture tolerance, degradation, trend, tendency, imperfect practical condition(s), etc.

### BRIEF DESCRIPTION OF THE DRAWINGS

Embodiments of the invention will now be described, by way of example, with reference to the accompanying drawings in which:

FIG. 1 is a schematic diagram illustrating a system containing a query server and multiple user devices in one example;

FIG. 2 is a schematic diagram illustrating a query operation in one example;

FIG. 3A is a schematic diagram illustrating training of a neural network based ranking model in one example;

FIG. 3B is a schematic diagram illustrating testing of the neural network based ranking model trained in FIG. 3A;

FIG. 4 is a flowchart illustrating a computer-implemented method for training a neural network based ranking model in some embodiments of the invention;

FIG. 5 is a schematic diagram illustrating a training data augmentation operation in some embodiments of the invention;

FIG. 6 is a flowchart illustrating a method of training data augmentation in some embodiments of the invention;

FIG. 7 is a flowchart illustrating a method of generating synthesized training data in some embodiments of the invention;

FIG. 8 is a schematic diagram illustrating a ranking or scoring operation performed using a neural network based ranking model in some embodiments of the invention;

FIG. 9 is a schematic diagram illustrating a data perturbation operation in some embodiments of the invention;

FIG. 10 is a schematic diagram illustrating a contrastive learning operation in some embodiments of the invention;

FIG. 11 is a flowchart illustrating a method of joint optimization in some embodiments of the invention;

FIG. 12 is a data augmentation and contrastive learning framework long-tail learning to rank (DCLR) framework in one embodiment of the invention;

FIG. 13 is a table showing performance of the DCLR framework of FIG. 12 and other methods on two different datasets (Tiangong-ULTR dataset and Istella-S dataset);

FIG. 14 is a table showing ablation study result of the DCLR framework of FIG. 12 on the Tiangong-ULTR dataset; and

FIG. 15 is a block diagram of a data processing system in some embodiments of the invention, which can be used to perform, partly or entirely, one or more of the methods of the invention.

### DETAILED DESCRIPTION

As used herein, unless otherwise specified, the term “document” is used generally to refer to any item of information such as digital image, photograph, electronic document or file, email message, voice mail message, short message service message, web page, part of a web page, map, electronic link, commercial product, multimedia file, song, book, album, article, database record, a summary of any one or more of these items, etc. Such information be retrieved using or by a query server (e.g., search engine).

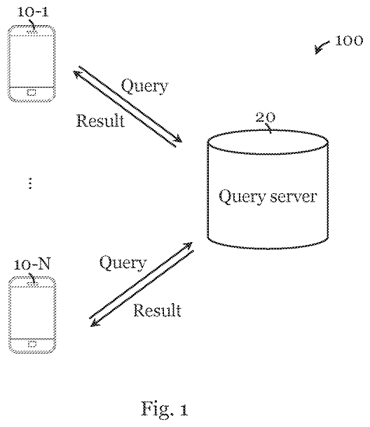

FIG. 1 illustrates an example system 100 with N user devices 10-1 to 10-N (N can be any integer) operably connected with a query server 20. Each of the user devices 10-1 to 10-N are arranged to be in communication with the query server 20 via one or more communication links, which can be wired or wireless. The user device 10-1 to 10-N is arranged to transmit a query to the query server 20. The query server 20 is arranged to receive and process the query, then provide a query result back to the user device 10-1 to 10-N. The query may be related to a search, and the query result may include multiple documents that are determined by the query server 20 to be most relevant to the search.

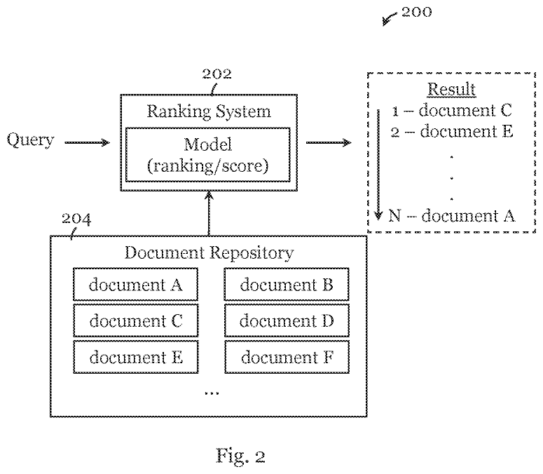

FIG. 2 illustrates an example query operation 200 performed by a ranking system 202. The ranking system 202 includes a raking or scoring model, which may be a neural network based model, arranged to perform ranking or scoring tasks to rank or score candidate documents associated with the query. In this example, the ranking system 202 is operably connected with a document repository 204, which stores information related to candidate documents. The ranking system is arranged to retrieve or receive the information related to candidate documents from the document repository 204. In operation, the ranking system 202 receives a query, e.g., from a user device, as well as retrieves or receives the information related to candidate documents from the document repository 204. The ranking system 202 then processes the query and the information using the ranking or scoring model to generate a result, which may then be provided to the user device submitting the query. The ranking or scoring model may provide a respective rank or score for some or all of the candidate documents. The result generated by the ranking system 202 may include a list of candidate documents ordered according to their determined relevance to the query. For example, the candidate documents may be ordered in ascending order or descending order, with or without filtering one or more results. In some operations, the user at the user device may, in response to the result, select one or more documents from the list. For example, the user may provide a user feedback or input (e.g., click) at a user device to select one or more documents from the list. This user feedback or input indicates that the user may consider that the select one or more documents to be more relevant to the query than the other documents. The user feedback or input may be received by a query server, and stored for subsequent use in training the model of the ranking system 202.

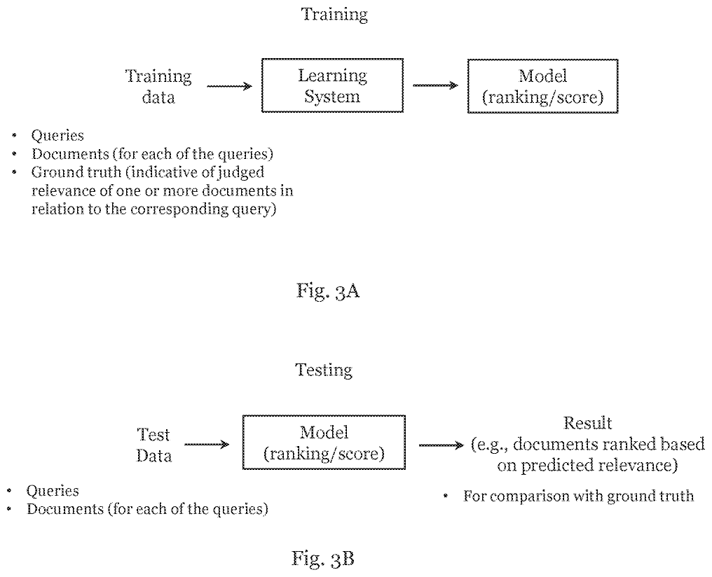

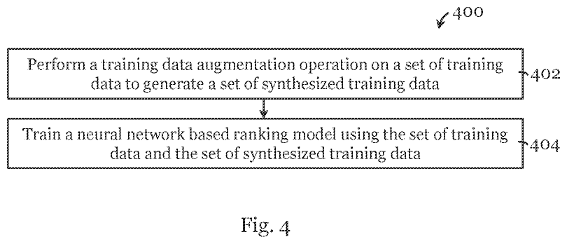

FIG. 3A illustrates a general process for generating or training a neural network based ranking or scoring model, such as the one in the ranking system 202 of FIG. 2. The process includes providing training data to learning system for processing. The learning system is arranged to generate or optimize a ranking or scoring model based on the training data. In this example, the training data may include multiple queries, multiple documents for the queries (e.g., each query may include multiple documents), and ground truth. The ground truth is indicative of judged relevance (e.g., a score, a rank, etc.) of one or more documents in relation to the corresponding query. The judged relevance may be obtained from user feedback (e.g., user input, user behavior, etc.), e.g., as detected or received at the user device in response to the query result.

FIG. 3B illustrates a general process for testing the trained ranking or scoring model of FIG. 3A. The process includes providing testing data to the trained ranking or scoring model for processing. In this example, the testing data may have the same format as the training data, except that the ground truth is not provided to the trained ranking or scoring model. The trained ranking or scoring model is arranged to process the testing data (queries and documents) and generate results corresponding to the queries. For example, each result includes documents ranked based on predicted relevance to the query. The ground truth of the testing data is used to compare against the result generated by the trained ranking or scoring model to determine its performance. If it is determined that the performance of the trained ranking or scoring model is not sufficient, then further training of the trained ranking or scoring model may be performed.

FIG. 4 shows a general computer-implemented method 400 for training a neural network based ranking model in some embodiments of the invention. The method 400 includes, in step 402, performing a training data augmentation operation on a set of training data to generate a set of synthesized training data. The set of training data includes, for each of a plurality of queries, respective query-document data and respective relevance judgement data. The query-document data for a query comprises data associated with a plurality of query-documents pairs for the query. The relevance judgement data for a query comprises one or more sets of user feedback (e.g., user click) data associated with the query. The set of training data has an imbalanced training data distribution such that amounts of relevance judgement data available for at least some the plurality of queries are different. The set of synthesized training data generated by step 402 is arranged for use to reduce training data distribution imbalance of the set of training data. In some embodiments the imbalanced training data distribution of the set of training data generally follows a long-tail distribution or a heavy-tail distribution. The method 400 also includes, in step 404, training a neural network based ranking model using the set of training data and the set of synthesized training data. The training of the neural network based ranking model in step 404 may include various operations as will be further discussed below.

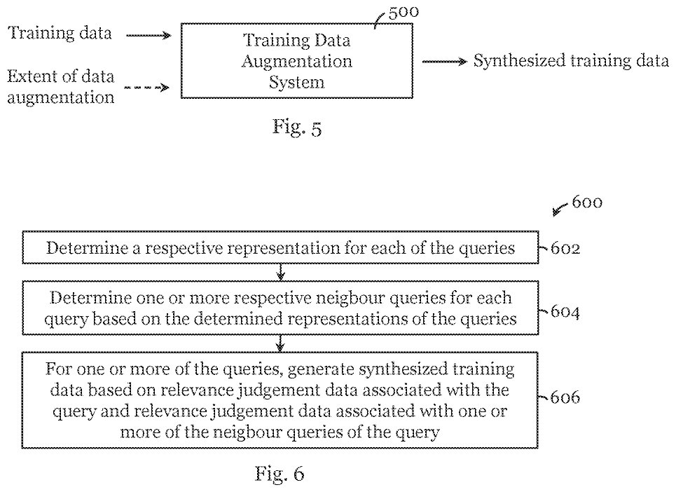

FIG. 5 illustrates a training data augmentation operation in some embodiments of the invention. In some embodiments, the training data augmentation operation of FIG. 5 may be considered to belong to the training data augmentation operation in step 402 of FIG. 4. For ease of presentation, unless otherwise specified, the following description in relation to the training data augmentation operation of FIG. 5 is provided with reference to step 402 of FIG. 4.

As shown in FIG. 5, the training data is processed by a training data augmentation system 500 to generate synthesized training data. The training data and the synthesized training data may be those described with reference to the training data augmentation operation in step 402 of FIG. 4. Specifically, the training data has imbalance or skewed data distribution and the synthesized training data is arranged to reduce such imbalance or skewed data distribution (to make the data distribution more balanced or less skewed). In some embodiments, the training data augmentation system 500 is arranged to also receive data associated with the extent of data augmentation required, and is arranged to generate synthesized training data in accordance with the extent of data augmentation required. For example, the extent of data augmentation required may affect the amount of synthesized training data generated. If a smaller extent of data augmentation is needed, then a smaller amount of synthesized training data is generated, and vice versa. The extent of data augmentation required relates to the extent of reduction of the imbalance or skewed data distribution of the training data. The extent of data augmentation required may be adjusted as needed.

FIG. 6 shows a method 600 for training data augmentation in some embodiments of the invention. In some embodiments, the method 600 may be considered to belong to the training data augmentation operation in step 402 of FIG. 4. For ease of presentation, unless otherwise specified, the following description in relation to the method 600 of FIG. 6 is provided with reference to step 402 of FIG. 4.

The method 600 includes, in step 602, determining a respective representation for each of the queries. In some embodiments, each of the queries may respectively correspond to multiple query-document pairs with corresponding features (e.g., feature vectors) and the determining of the representation of each respective query is based on the corresponding features of the query. For example, the determining of the representation of each respective query is based on a statistical measure (e.g., mean) of the corresponding features of the query.

The method 600 also includes, in step 604, determining one or more respective neighbor queries for each query based on the determined representations of the queries. In some embodiments, this determination can be performed using a k-nearest-neighbor (KNN) method.

The method 600 also includes, in step 606, for one or more of the queries, generating synthesized training data based on relevance judgement data associated with the query and relevance judgement data associated with one or more of the neighbor queries of the query. In some embodiments, synthesized training data is only generated for one or some of the queries, to address the data distribution imbalance problem mentioned above.

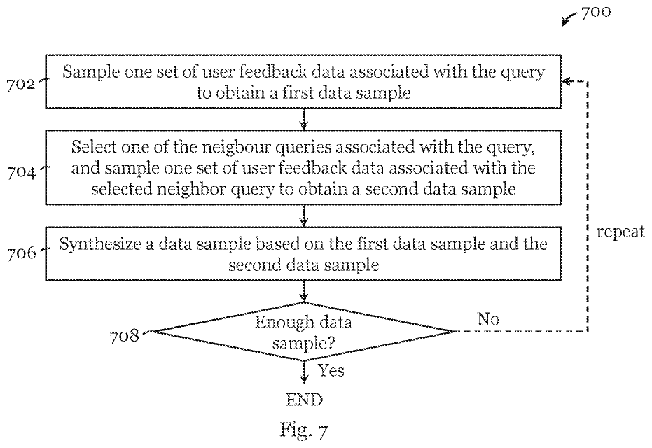

FIG. 7 shows a method 700 of generating synthesized training data in some embodiments of the invention. In some embodiments, the method 700 can be considered as an example implementation of step 606 for each query in method 600 of FIG. 6. The method 700 can be repeated for different ones of the queries in method 600 of FIG. 6. For ease of presentation, unless otherwise specified, the following description in relation to the method 700 of FIG. 7 is provided with reference to step 606 of FIG. 6.

The method 700 includes, in step 702, sampling, from multiple sets of user feedback data associated with the query, one set of user feedback data associated with the query to obtain a first data sample. The sampling in step 702 may be random or pseudorandom.

The method 700 also includes, in step 704, selecting one of the neighbor queries associated with the query, and sampling, from multiple sets of user feedback data associated with the selected neighbor query, one set of user feedback data associated with the selected neighbor query to obtain a second data sample. The selection in step 704 may be random or pseudorandom. The sampling in step 704 may be random or pseudorandom.

Steps 702 and 704 may be performed in any order or simultaneously.

The method 700 also includes after steps 702 and 704, in step 706, selecting synthesizing a data sample based on the first data sample and the second data sample. In some embodiments, the synthesizing of the data sample is based on:

$${l}^{′} = λ {l}_{{q}_{i}} + ( 1 - λ ) {l}_{{q}_{j}}$$

where l′ is the synthesized data sample, l_{qi} is the first data sample, l_{qj} is the second data sample, and λ is a hyper-parameter. Preferably, 0<λ<1 such that the operation does not correspond to data resampling.

The method 700 also includes, in step 708, determining whether enough data sample has been synthetized for the query. If it is determined that sufficient amount of data sample has been synthetized for the query, then the method 700 ends. If it is determined that further data sample needs to be synthetized for the query, then the method 700 returns back to step 702 (or step 704, as steps 702 and 704 may be performed in any order or simultaneously). In some embodiments, the number of repeat of steps 702 to 706 for each respective one of the queries is dependent on hence adaptive to an amount of available user feedback data associated with the query.

In some embodiments, the method 700 further includes determining, based on the relevance judgement data for the queries, frequency of occurrence or relative frequency of occurrence of each of the queries, and the number of repeat of steps 702 to 706 for each respective one of the queries is dependent on the determined frequency of occurrence or relative frequency of occurrence of the corresponding query. In some embodiments, the relative frequency of occurrence of a query is determined based on:

$${T}_{{q}_{i}} = log ( {t}_{i} + 1 )$$

where T_{qi} corresponds to a tailness measure of the query, and tᵢ is a number of sets of user feedback data for the query. In some embodiments, the number of repeat of steps 702 to 706 for each respective one of the queries is associated with a weighting factor wᵢ defined as:

$${w}_{i} = max ( \frac{{T}_{max} - {T}_{i}}{{T}_{max} - {T}_{min}} \cdot {w}_{e} , {w}_{c} )$$

where wₑ is a hyper-parameter that controls an overall weight of synthesizing data samples, Tₘₐₓ and Tₘᵢₙ are maximum and minimum values of T respectively, and w_{c} is a threshold value.

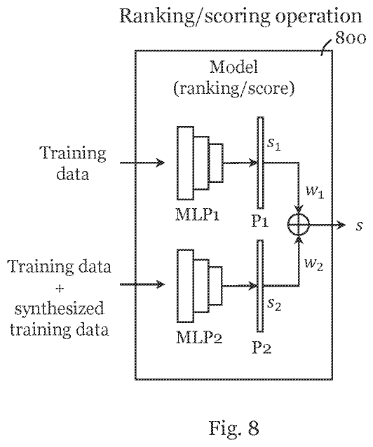

FIG. 8 illustrates a ranking or scoring operation performed using a neural network based ranking model 800 in some embodiments of the invention. In some embodiments, the ranking or scoring operation of FIG. 8 may be considered to belong to the training operation in step 404 of FIG. 4. The training of the neural network based ranking model in step 404 may include performing a ranking or scoring operation (such as the ranking or scoring operation FIG. 8) based on the set of training data and the set of synthesized training data using the neural network based ranking model. For ease of presentation, unless otherwise specified, the following description in relation to the ranking or scoring operation of FIG. 8 is provided with reference to step 404 of FIG. 4.

As illustrated in FIG. 8, in some embodiments, the neural network based ranking model includes multiple model branches. In some embodiments, the neural network based ranking model includes a first model branch with a multilayer perceptron MLP1 and a predictor P1 operably coupled with the multilayer perceptron MLP1, a second model branch with a multilayer perceptron MLP2 and a predictor P2 operably coupled with the multilayer perceptron MLP2, and a combiner for combining the outputs of predictors P1, P2. In some examples, the multilayer perceptrons MLP1, MLP2 may have the same model architecture/structure. In some examples, the predictors P1, P2 may have the same architecture/structure. In some embodiments, the combiner is arranged to apply a weighting W1 to the output of the predictor P1 and/or a weighting w₂ to the output of the predictor P2.

As illustrated in FIG. 8, the ranking or scoring operation includes processing the set of training data with the first model branch and processing a combination of the set of training data and the set of synthesized training data (e.g., synthesized based on the methods of FIGS. 5-7) with the second model branch. In some embodiments, a ranking or scoring loss [symbol] can be determined based on the performing of the ranking or scoring operation.

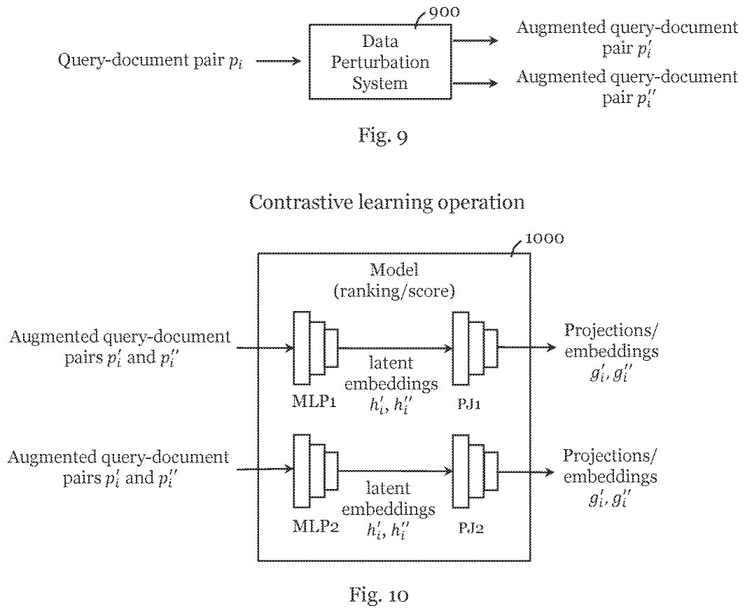

FIG. 9 illustrates a data perturbation operation in some embodiments of the invention. The data perturbation operation is arranged to facilitate a contrastive learning operation. As shown in FIG. 9, a query-document pair pi is processed by a data perturbation system 900 to generate augmented query-document pair(s), which includes two augmented query-document pairs pᵢ′ and pᵢ″ in some embodiments. The data perturbation operation may be performed for one or more of the query-document pairs of a query, and be performed for one or more of the queries. In some embodiments, the data perturbation system 900 is arranged to add noise to the query-document pair pᵢ to generate the augmented query-document pair(s).

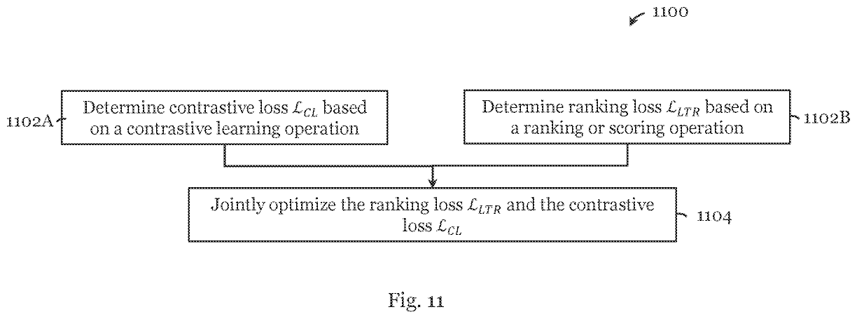

FIG. 10 illustrates a contrastive learning operation in some embodiments of the invention. In some embodiments, the contrastive learning operation in FIG. 10 may be considered to belong to the training in step 404 of FIG. 4. The training of the neural network based ranking model in step 404 may include performing a contrastive learning operation (such as the contrastive learning operation of FIG. 10) based on the set of training data and/or the set of synthesized training data using the neural network based ranking model. For ease of presentation, unless otherwise specified, the following description in relation to the contrastive learning operation of FIG. 10 is provided with reference to step 404 of FIG. 4.

Although not illustrated in FIG. 10, in some embodiments, the contrastive learning operation includes: for one or more of the queries, for data associated with each of the query-documents pairs of the query, performing a data perturbation operation to generate respective augmented data for the data of each of the query-documents pairs. The data perturbation operation may be the data perturbation operation of FIG. 9. The contrastive learning operation may be performed for one or multiple queries.

In some embodiments, the contrastive learning operation includes processing the augmented data using the neural network based ranking model. As shown in FIG. 10, the neural network based ranking model includes: a first branch with a multilayer perceptron MLP1 and a projector PJ1 and a second branch with a multilayer perceptron MLP2 and a projector PJ2. In some embodiments, the multilayer perceptrons MLP1 and MLP2 in the model 1000 may be the multilayer perceptrons MLP1 and MLP2 in the model 800 in FIG. 8. In some examples, the multilayer perceptrons MLP1, MLP2 in the model 1000 may have the same model architecture/structure. In some examples, the projectors PJ1, PJ2 may have the same architecture/structure. In some examples, the projectors PJ1, PJ2 may be multilayer perceptrons.

As illustrated in FIG. 10, the contrastive learning operation may include processing the augmented query-document pairs pᵢ′ and pᵢ″ (obtained from the data perturbation operation of FIG. 9) using the first branch and the second branch of the model 1000 respectively. Specifically, the processing may include: (1) processing the augmented query-document pairs pᵢ′ and pᵢ″ using the multilayer perceptron MLP1 to obtain latent embeddings hᵢ′, hᵢ″, and processing the latent embeddings hᵢ′, hᵢ″ with the projector PJ1 to obtain projections/embeddings g₁′, g₁″; (2) processing the augmented query-document pairs pᵢ′ and pᵢ″ using the multilayer perceptron MLP2 to obtain latent embeddings hᵢ′, hᵢ″, and processing the latent embeddings hᵢ′, hᵢ″ with the projector PJ2 to obtain projections/embeddings gᵢ′, gᵢ″. In some embodiments, a contrastive loss [symbol] can be determined based on the performing of the projections/embeddings g₁′, g₁″.

In some embodiments, the model 800 of FIG. 8 and the model 1000 of FIG. 10 may be combined or integrated.

FIG. 11 shows a method 1100 of joint optimization in some embodiments of the invention. In some embodiments, the method 1100 may be performed based on the ranking or scoring operation in FIG. 8 and the contrastive learning operation in FIG. 10.

The method 1100 includes, in step 1102A, determining contrastive loss [symbol] based on a contrastive learning operation such as the contrastive learning operation in FIG. 10, and, in step 1102B, determining ranking loss [symbol] based on a ranking or scoring operation such as the ranking or scoring operation in FIG. 8. Steps 1102A and 1102B may be performed in any order or simultaneously.

The method 1100 also includes, in step 1104, jointly optimizing the determined ranking loss [symbol] and the contrastive loss [symbol] . In some embodiments, this may include optimizing the models 800, 1000, in particular the multilayer perceptrons MLP1, MLP2 in the models 800, 1000. In some embodiments, the step 1104 includes optimizing an overall loss [symbol] that equals to [symbol] +γ [symbol] , where γ is hyper-parameter.

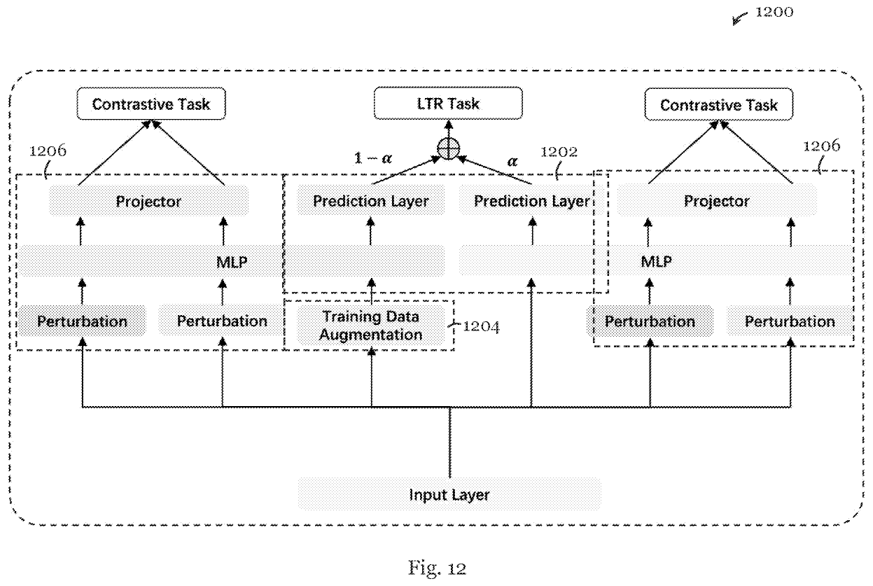

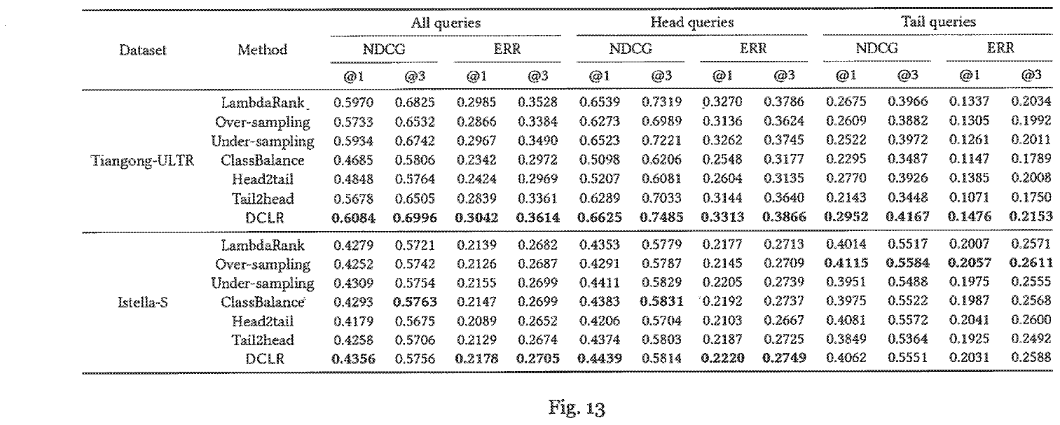

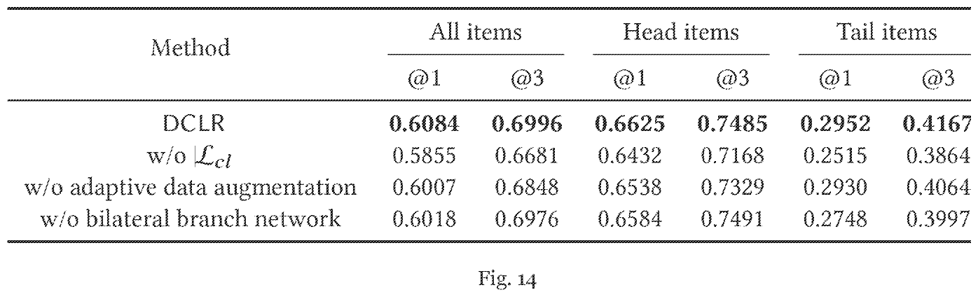

The following description in relation to FIGS. 12 to 14 provide an example neural network based ranking model training technique.

In existing search engine systems, learning to rank (LTR) learns a model (ranker) from user click data and returns the order of a list of candidate documents. According to Zou et al., “A large scale search dataset for unbiased learning to rank” (2022), the user click behavior may follow a long-tail distribution. In other words, some more-popular queries have many user clicks (i.e., head queries). These queries are likely to perform better than queries with fewer clicks (i.e., tail queries) in LTR as the data imbalance may cause the ranker to focus more on the head part. This may thus cause unfairness for tail queries. This problem can be described as long-tail LTR. The following example aims to address this problem, to improve tail query performance.

One embodiment of the invention provides a data augmentation and contrastive learning framework long-tail LTR (also referred to as “DCLR”). DCLR of this embodiment adopts a bilateral branch network that can effectively learn from both the head and tail of the data distribution to overcome the challenge of learning from imbalanced training data distributions. DCLR of this embodiment uses an adaptive data augmentation module to synthesize new data, which helps to alleviate data scarcity in the tail. DCLR of this embodiment also incorporates contrastive learning to learn more uniform distribution for tail queries by creating multiple (e.g., two) augmented views and maximizing their agreement. DCLR of this embodiment also make use of a multi-task training strategy to optimize the model jointly.

In this following disclosure related to the DCLR embodiment, the long-tail LTR problem is studied and the DCLR design embodiment is presented. The DCLR embodiment makes use of a bilateral branch network to learn from different training data distributions and an adaptive data augmentation module to change the training data distribution to ease the data sparsity problem. The DCLR embodiment also makes use of contrastive learning module in long-tail LTR to learn more uniform representations via contrastive tasks.

Before describing the framework 1200 in FIG. 12, preliminaries applicable to this embodiment are now presented. Given a set of queries Q={q₁, . . . , qₚ} and each query q_{K}∈Q is associated with nₖ documents. Suppose many users browse on these queries and click on their interested documents. The cumulative query occurrences in all user click sessions yield a long-tail distribution. One of the objects of the framework 1200 in this embodiment is to improve the performance of tail queries (as well as the average performance across all the queries).

As shown in FIG. 12, the framework 1200 in this embodiment consists of LTR and contrastive tasks. A bilateral branch network structure and an adaptive data augmentation module are incorporated into the LTR task. The contrastive task includes ad-hoc data perturbation and contrastive loss. A multi-task training strategy is applied to perform joint optimization. Note that the framework 1200 in this embodiment is model-agnostic for the neural network based learning to rank model (also called “neural ranker”).

FIG. 12 shows a bilateral branch network module/structure 1202 in one embodiment, which can be used to adjust the weight for the long-tail part, thus could ease the long-tail problem. Specifically, the two branches have the same network structure but with different input data. The input data is directly processed in one branch of the neural network based learning to rank model, and is augmented adaptively before being processed in one branch of the neural network based learning to rank model. Details of the adaptive augmentation are provided below. After passing through multi-layer perceptions (MLP) and prediction layers of the bilateral branch network structure 1202, the outputs for the two branch networks (prediction layers) are combined based on:

$$s = α {s}_{1} + ( 1 - α ) {s}_{2} \qquad ( 1 )$$

where s is the final output prediction score for LTR task, s₁ and s₂ are the prediction score by each branch, and a is a hyper-parameter controlling the proportion for each branch.

FIG. 12 also shows an adaptive training data augmentation module 1204 in one embodiment. Since the training data is highly skewed, data augmentation operation is performed to synthesize new data and change the training data distribution. In this embodiment, the representation for each query is first obtained. Suppose a query qᵢ is corresponding to a set of query documents pairs { [symbol] qᵢ, d₁ [symbol] , . . . , [symbol] qᵢ, dₙ [symbol] }, with corresponding feature {f_{i,1}, . . . , f_{i,n}}. In this embodiment, qᵢ is represented as the average of these features, i.e.,

$${f}_{i} = \frac{1}{n} {\sum }_{m = 1}^{n} {f}_{i , m} .$$

Then, the semantic neighbors for each query are obtained. In this embodiment, the kNN algorithm is applied to find k nearest neighbors of query qᵢ in the semantic space. The k nearest neighbors can be demoted as {q_{i,1}, . . . , q_{i,k}}. Then, training data is synthesized based on existing training data. In one embodiment, a user click session on query qᵢ (i.e., a list of query-documents pair and corresponding user click feedback), denoted as l_{qj}, is randomly sampled. Also, a query qⱼ∈{q_{i,1}, . . . , q_{i,k}} is randomly chosen and a corresponding user click session l_{qj} is sampled. Then, in this embodiment, the two data samples are mixed based on:

$${l}^{′} = λ {l}_{{q}_{i}} + ( 1 - λ ) {l}_{{q}_{j}} \qquad ( 2 )$$

where l′ is the synthesized data sample, λ is a hyper-parameter controlling the proportion of the two data samples. Note that when λ=0 or λ=1, then this is the same as data resampling. Preferably, λ is not equal to 0 or 1.

In this embodiment, an adaptive sampling strategy is also applied. First, tailness, which describes the extent that a query is located at the tail part, is defined. Suppose a query qᵢ occurs tᵢ times in all user click sessions. Then the tailness of query qᵢ, denoted as T_{qi}, is defined as T_{qi}=log(tᵢ+1). Suppose wᵢ is the weight to control the data augmentation (i.e., number of synthesized samples) for query qᵢ, then it is defined as:

$${w}_{i} = max ( \frac{{T}_{max} - {T}_{i}}{{T}_{max} - {T}_{min}} \cdot {w}_{e} , {w}_{c} ) \qquad ( 3 )$$

where wₑ is a hyper-parameter that controls the overall weight of adding data samples, Tₘₐₓ and Tₘᵢₙ is the maximum and minimum value of T, and w_{c} is the cut-off value.

FIG. 12 also shows a contrastive learning module 1206 in one embodiment. In this embodiment, contrastive learning is deployed in long-tail LTR to learn better representations. Based on standard paradigms of contrastive learning, two augmented views are constructed for the input data. Then the augmented views are passed to and processed by the neural network MLPs to obtain two latent vectors. A contrastive loss is applied to minimize the distance between the two representations.

Inventors of the present invention have devised that data augmentation is important in contrastive learning, and that different data augmentation methods may be required for different situations or applications. This embodiment employs a task-oriented augmentation approach for long-tail LTR to perturb the input data and facilitate the representation learning process.

In this embodiment, given a set of query-document pairs P, for each query-document pair pᵢ∈P with d-dimension feature, data augmentation is conducted and two augmented views are generated. Random noise injection method is applied in this embodiment to perturb the input data. The process is denoted as follows:

$${p}_{i}^{′} = {p}_{i} + ϵ \frac{{Δ}_{i}^{′} ⊙ sign ( {x}_{i} )}{{‖ {Δ}_{i}^{′} ‖}_{2}} , {p}_{i}^{″} = {p}_{i} + ϵ \frac{{Δ}_{i}^{″} ⊙ sign ( {x}_{i} )}{{‖ {Δ}_{i}^{″} ‖}_{2}} \qquad ( 4 )$$

where each element of Δᵢ′ and Δᵢ″ is uniformly sampled from [0, 1]. ϵ is a small positive constant. This may ensure that the addition of the noise to the input data would not result in a large deviation.

In this embodiment, the neural network based learning to rank model uses a multi-layer perception (MLP) to process the input data and obtain a latent embedding, then uses a prediction layer to predict the output score based on the latent embedding. Therefore, after random perturbation, these two inputs pass through layers before the final output layer in a neural network based learning to rank model to obtain latent embeddings hᵢ′ and hᵢ″, denoted as:

$${h}_{i}^{′} = MLP ( {p}_{i}^{′} ) , {h}_{i}^{″} = MLP ( {p}_{i}^{″} ) \qquad ( 5 )$$

Next, a non-linear projector is used to project the latent embeddings, denoted as:

$${g}_{i}^{′} = Project ( {h}_{i}^{′} ) , {g}_{i}^{″} = Project ( {h}_{i}^{″} ) \qquad ( 6 )$$

In this embodiment, the projectors are implanted using another tower-shaped MLP. Following the paradigms of contrastive learning, the agreement of gᵢ′ and gᵢ″ is maximized.

The framework 1200 of this embodiment also adopts contrastive loss, InfoNCE as disclosed in M. Gutmann et al., Noise-contrastive estimation: A new estimation principle for unnormalized statistical models, to maximize the agreement of positive pairs and minimize that of negative pairs. Suppose the gᵢ′ and gᵢ″ are the embedding for two views generated by random perturbation, then the contrastive loss [symbol] is denoted as:

$${ℒ}_{C L} = {\sum }_{i ∈ P} - log \frac{exp ( s ( {g}_{i}^{′} , {g}_{i}^{″} / τ ) )}{{\sum }_{i ∈ P} exp ( s ( {g}_{i}^{′} , {g}_{i}^{″} / τ ) )} \qquad ( 7 )$$

where s( ) measures the similarity between two vectors, which is set as a cosine similarity function; τ is the hyper-parameter, known as the temperature in softmax. In this way, the representation learning could be enhanced and facilitate the model training.

The framework 1200 of this embodiment utilizes a multi-task training strategy to jointly optimize the learning to rank loss and contrastive loss. The learning to rank loss, denoted as [symbol] , varies with the type of neural network based learning to rank model. In this embodiment, the overall loss is denoted as:

$${ℒ}_{o v e r a l l} = {ℒ}_{L T R} + {γℒ}_{C L} \qquad ( 8 )$$

where γ is a hyper-parameter controlling the strength of contrastive loss.

Experiments are performed to evaluate the performance of the DCLR framework of FIG. 12.

Real-world dataset named Tiangong-ULTR (available at http://www.thuir.cn/data-tiangong-ultr/), which contains real user click behaviors, are used in the experiment. The data is pre-processed. Specifically, sessions without user clicks are filtered out, then 457 queries, 7743 documents, and 46412 valid click sessions are randomly sampled from the dataset. Each click sessions contain 10 documents. The feature dimension for each query-document pair is 33.

User clicks are simulated using another dataset Istella-S, disclosed in C. Lucchese, et al., Post-learning optimization of tree ensembles for efficient ranking, following the method disclosed in Q. Ai, et al., Unbiased Learning to Rank with Unbiased Propensity Estimation, and D. Luo et al., Model-based unbiased learning to rank. 788 queries, 66143 documents, and 46994 valid click sessions are sampled. Each document-query pair is represented by 220 dimension features. The cascade model disclosed in N. Craswell et al., An experimental comparison of click position-bias models, is used to generate the examination probability, which assumes that the user decides whether to click each result before moving to the next and stop after the first click. The Pareto distribution is used to simulate the user's click on each query.

A number of existing models are also tested to compare against the DCLR framework 1200 in the embodiment of FIG. 12:
LambdaRank, disclosed in Burge, From ranknet to lambdarank to lambdamart: An overview.
Resampling strategies—over-sampling and under-sampling, disclosed in Jason Brownlee, Imbalanced classification with Python: better metrics, balance skewed classes, cost-sensitive learning. Briefly, oversampling samples more from tail queries to re-balance the head queries and tail queries in the training data distribution whereas undersampling keeps the tail queries unchanged and down-sample the head queries in contrast to over-sampling.
An example loss function refinement method—ClassBalance disclosed in Cui et al., Classbalanced loss based on effective number of samples. ClassBalance calculates the effective number of samples to reweight loss for each class.
Example curriculum learning strategies—Head2tail and Tail2head disclosed in Zhang, et al., A model of two tales: Dual transfer learning framework for improved long-tail item recommendation. Head2tail operates to train the neural network based learning to rank model with head queries in the first curriculum stage, then fine-tune the ranker with tail queries only in the second curriculum stage. Tail2head follows the opposite step, i.e., first trains on the tail queries, then fine-tune on the head queries.

To evaluate the performance of all methods, in the experiments, the commonly-used normalized discounted cumulative gain (NDCG) (disclosed in Järvelin et al., Cumulated gain-based evaluation of IR techniques) and Expected Reciprocal Rank (ERR) (disclosed in Chapelle et al., Expected reciprocal rank for graded relevance) are used as the metrics. For both metrics, the results at ranks 1 and 3 are reported to show the performance of models at different positions.

The Pareto Principle (disclosed in Box et al., An analysis for unreplicated fractional factorials) as the criteria to split the head and tail queries. In this experiment, the top-ranked 20% number of occurrence of queries are set as head queries and the rest are set as tail queries. The metrics evaluated on the tail and head query sets are reported. In this experiment, the training set, validation set, and testing set are split randomly by 7:1:2. Cross-validation is adopted to choose the best hyper-parameter. A two-layer MLP is adopted for the LTR model (for MLP1, MLP2), the first and second layers have 32 and 16 nodes, respectively. Another two-layer MLP is adopted for the projector (for PJ1, PJ2), where the node numbers are 16 and 8. In this experiment: the batch size is 256, τ is 0.15, γ is 0.1, λ is set to 0.5, and ε is 0.2. For fair comparison, these settings are kept the same in all experiments except otherwise specified.

The DCLR model in the embodiment of framework 1200 of FIG. 12 and the various existing models are evaluated using the two datasets to explore the model's performance under different scenarios.

Table 1 summarizes the LTR performance of all queries, head queries, and tail queries on these datasets. It can be seen that compared to LambdaRank, DCLR generally achieves improvements for both tail and head queries. This indicates the importance of considering contrastive learning and training data augmentation among queries in the long-tail distribution. The result shows the framework 1200 can benefit the long-tail LTR problem. It can also be seen that DCLR outperforms the reweighting methods (i.e., oversampling, under-sampling) on all three splits. Among these methods, over-sampling is generally worse than under-sampling. However, the resampling method may change the original data distribution and thus negatively affect the overall model performance. For the refining loss function strategies, a possible reason is their tradeoff between head and item items is not healthy, or may be harmful. It can also be seen that compared with curriculum learning based models, DCLR provides better performance. The results demonstrate the usefulness of combining data perturbation with contrastive learning to learn more uniform and robust representations. This would benefit the model's performance.

Ablation study is also performed to analyze different components of the DCLR framework 1200 in the framework 1200 of FIG. 12. Table 2 shows the result of the ablation study. It can be seen that the full model outperforms all variants on three splits, which indicates that all main components contribute to performance improvement.

One of the ablation studies is performed without [symbol] . In this variant, the contrastive loss [symbol] is removed, and only the LTR loss [symbol] is used to train the model. It can be seen that DCLR without contrastive loss [symbol] performs worse. This implies that [symbol] could effectively enhance the representation and learn more uniform and robust latent embeddings. This could improve the model's performance.

Another one of the ablation studies is performed without adaptive data augmentation: In this variant, the adaptive data augmentation is replaced with uniform data augmentation (other components remain the same). It can be seen that the model's performance without the adaptive data augmentation is worse on tail queries, which indicates that adaptive data augmentation benefits the performance of tail queries since it could keep more critical information for tail queries.

Yet another one of the ablation studies is performed without bilateral branch network: In this variant, the bilateral branch network is removed (other components remain the same). It can be seen that without the bilateral branch network, the tail queries have performance degradation. This shows that the combination of two branches would benefit the long-tail performance.

The above DCLR embodiment of the invention has provided a data augmentation and contrastive learning based framework to solve the long-tail LTR problem. The DCLR employs a bilateral branch network to dynamically adjust the training data distribution, a training data augmentation module to improve model generalization ability by synthesizing data, and a contrastive learning module to improve representation learning by leveraging the contrastive signals from the features.

Embodiments of the invention may provide one or more of the following advantages. For example, some embodiments of the invention address the long-tail learning to rank problem. Some embodiments of the invention are specifically designed to address the long-tail learning to rank problem, which is not effectively tackled by existing technologies. By improving the performance of tail queries without compromising that of head queries, the algorithm can provide a fairer and more balanced ranking system. For example, some embodiments of the invention make use of data augmentation and contrastive learning. For example, some embodiments of the invention utilize a combination of data augmentation and contrastive learning techniques to improve the model's ability to generalize to unseen examples and learn a more uniform and robust representation. This combination of techniques can lead to more effective learning and better performance. For example, some embodiments of the invention utilize dynamic weighting for head and tail queries. For example, some embodiments of the invention provide a bilateral branch network module that dynamically adjusts the weighting for head and tail queries. This means that the model in some embodiments can adapt to different data distributions and provide better performance for both head and tail queries. For example, some embodiments of the invention can be used in a wide range of scenarios. For example, some embodiments of the invention can be applied in various fields where learning to rank algorithms are used, including search engines, e-commerce, advertising, and recommender systems. This means that the algorithm has broad applicability and can be useful in many different contexts. For example, some embodiments of the invention provide a more effective and fairer ranking system by addressing the long-tail learning to rank problem, utilizing novel data augmentation and contrastive learning techniques, and adapting to different data distributions. These advantages make the algorithm of these embodiments a promising solution for various scenarios where learning to rank is important. Embodiments of the invention may provide one or more additional or alternative advantages not specifically described.

Some embodiments of the invention effectively address the long-tail learning to rank problem in learning to rank scenarios. The long-tail learning to rank problem refers to the performance imbalance between head queries (i.e., with lots of user clicks) and tail queries (i.e., with fewer user clicks), which creates an unfair situation for the latter. Some embodiments of the invention provide a data augmentation and contrastive learning method, such as the DCLR model, to address this problem. Some embodiments of the invention provide an algorithm that uses a bilateral branch network module that adjusts the weighting for head and tail queries dynamically, an adaptive training data augmentation module to synthesize data and modify the training data distribution, and contrastive learning to learn a more uniform and robust representation.

Embodiments of the invention can be applied in various fields where learning to rank algorithms are used. These fields include, e.g.,
Search Engines: The algorithm can be used to improve the ranking of less popular search queries, leading to an enhanced user experience and increased click-through rates.
E-commerce: The algorithm can be used to improve product recommendations for less popular products, leading to higher sales and improved customer satisfaction.
Advertising: The algorithm can be used to improve the targeting of ads for less popular keywords, leading to higher click-through rates and improved ROI.
Recommender systems: The algorithm can be used to improve the recommendations for less popular items, leading to a better user experience and increased engagement.

More generally, embodiments of the invention can be applied in any scenario where training data imbalance in learning to rank is a problem, and can improve the performance of tail queries without compromising that of head queries.

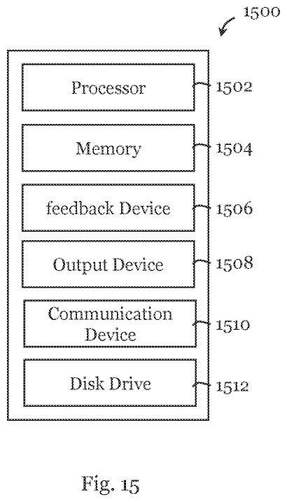

FIG. 15 shows an example data processing system 1500 that can be used as a server (e.g., query server 20), a user device (user device 10-N) or another type of data processing system in one embodiment of the invention. The data processing system 1500 generally comprises suitable components necessary to receive, store, and execute appropriate computer instructions, commands, and/or codes. The main components of the data processing system 1500 are a processor 1502 and a memory (storage) 1504. The processor 1502 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The processor 1502 may be arranged to perform data processing using machine learning based techniques and using non-machine learning based techniques. The memory 1504 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 1504. Computer instructions for executing or facilitating executing one or more of the method embodiments of the invention may be stored in the memory 1504. For example, the neural network based model of the embodiments of the invention may be stored in the memory 1504. For example, the training/testing/verification data for the neural network based model of the embodiments of the invention may be stored in the memory 1504. The processor 1502 and memory (storage) 1504 may be integrated or separated (and operably connected). Optionally, the data processing system 1500 further includes one or more input devices 1506. Example of such input device 1506 include: keyboard, mouse, stylus, image scanner, microphone, tactile/touch input device (e.g., touch sensitive screen), image/video input device (e.g., camera), etc. Optionally, the data processing system 1500 further includes one or more output devices 1508. Example of such output device 1508 include: display (e.g., monitor, screen, projector, etc.), speaker, headphone, earphone, printer, additive manufacturing machine (e.g., 3D printer), etc. The display may include a LCD display, a LED/OLED display, or other suitable display, which may or may not be touch sensitive. The data processing system 1500 may further include one or more disk drives 1512 which may include one or more of: solid state drive, hard disk drive, optical drive, flash drive, magnetic tape drive, etc. A suitable operating system may be installed in the data processing system 1500, e.g., on the disk drive 1512 or in the memory 1504. The memory 1504 and the disk drive 1512 may be operated by the processor 1502. Optionally, the data processing system 1500 also includes a communication device 1510 for establishing one or more communication links (not shown) with one or more other computing devices, such as servers, personal computers, terminals, tablets, phones, watches, IoT devices, or other wireless computing devices. The communication device 1510 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, above 5G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 1502, the memory 1504 (optionally the input device(s) 1506, the output device(s) 1508, the communication device(s) 1510 and the disk drive(s) 1512, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. A person skilled in the art would appreciate that the data processing system 1500 shown in FIG. 15 is merely an example and that the data processing system 1500 can in other embodiments have different configurations (e.g., include additional components, has fewer components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

Some embodiments of the invention concern inference using the trained neural network based ranking model (trained using one or more of the method embodiments of the invention). To this end, some embodiments of the invention provides a computer-implemented method for operating a neural network based ranking model (trained using one or more of the method embodiments of the invention). The method includes: processing a query and a set of document data (data associated with a plurality of documents) using the neural network based ranking model trained to determine a result. The method may further include: presenting (e.g., displaying) the result. The result may include a ranked or ordered list of documents.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings). For example, the neural network based ranking model of the invention can have different network architecture (i.e., different from those specifically described or illustrated).

1. A computer-implemented method for training a neural network based ranking model, comprising:
performing a training data augmentation operation on a set of training data to generate a set of synthesized training data; and
training a neural network based ranking model using the set of training data and the set of synthesized training data;
wherein the set of training data comprises, for each of a plurality of queries, respective query-document data and respective relevance judgement data, the query-document data for a query comprises data associated with a plurality of query-documents pairs for the query, and the relevance judgement data for a query comprises one or more sets of user feedback data associated with the query,
wherein the set of training data has an imbalanced training data distribution such that amounts of relevance judgement data available for at least some the plurality of queries are different, and
wherein the set of synthesized training data is arranged for use to reduce training data distribution imbalance of the set of training data.

2. The computer-implemented method of claim 1, wherein the imbalanced training data distribution generally follows a long-tail distribution or heavy-tail distribution.

3. The computer-implemented method of claim 1, wherein the training data augmentation operation comprises:
for each of the plurality of queries, determining a respective representation of the query;
for each of the plurality of queries, determining one or more respective neighbor queries based on the determined representations of the plurality of queries; and
for one or more of the plurality of queries, generating synthesized training data based on relevance judgement data associated with the query and relevance judgement data associated with one or more of the neighbor queries of the query.

4. The computer-implemented method of claim 3,
wherein each of the plurality of queries respectively corresponds to a plurality of query-document pairs with corresponding features; and
wherein the determining of the respective representation of the query is based on the corresponding features of the query.

5. The computer-implemented method of claim 4, wherein the determining of the respective representation of the query is based on a statistical measure of the corresponding features of the query.

6. The computer-implemented method of claim 5, wherein the determining of the respective representation of the query is based on a mean of the corresponding features of the query.

7. The computer-implemented method of claim 3, wherein the determining of the one or more respective neighbor queries is based on k-nearest-neighbor (KNN) method.

8. The computer-implemented method of claim 3, wherein the generating of synthesized training data for a query comprises:
(a) sampling, from a plurality of sets of user feedback data associated with the query, one set of user feedback data associated with the query to obtain a first data sample;
(b) selecting one of the neighbor queries associated with the query, and sampling, from a plurality of sets of user feedback data associated with the selected neighbor query, one set of user feedback data associated with the selected neighbor query to obtain a second data sample; and
(c) synthesizing a data sample based on the first data sample and the second data sample.

9. The computer-implemented method of claim 8, wherein the synthesizing of the data sample is based on:
$${l}^{′} = λ {l}_{{q}_{i}} + ( 1 - λ ) {l}_{{q}_{j}}$$
where l′ is the synthesized data sample, l_{qi} is the first data sample, l_{qj} is the second data sample, and λ is a hyper-parameter.

10. The computer-implemented method of claim 9, wherein 0<λ<1.

11. The computer-implemented method of claim 8, wherein the generating of synthesized training data for one or more of the plurality of queries respectively further comprises: repeating steps (a) to (c) to synthesize multiple data samples.

12. The computer-implemented method of claim 11, wherein number of repeat of steps (a) to (c) for each respective one of the queries is dependent on an amount of user feedback data associated with the query.

13. The computer-implemented method of claim 11, further comprises:
determining, based on the relevance judgement data for the plurality of the queries, frequency of occurrence or relative frequency of occurrence of each of the plurality of queries;
wherein number of repeat of steps (a) to (c) for each respective one of the queries is dependent on the determined frequency of occurrence or relative frequency of occurrence of the corresponding query.

14. The computer-implemented method of claim 13, wherein the relative frequency of occurrence of a query is determined based on:
$${T}_{{q}_{i}} = log ( {t}_{i} + 1 )$$
where T_{qi} corresponds to a tailness measure of the query, and tᵢ is a number of sets of user feedback data for the query.

15. The computer-implemented method of claim 14, wherein the number of repeat of steps (a) to (c) for each respective one of the queries is associated with a weighting factor wᵢ defined as:
$${w}_{i} = max ( \frac{{T}_{max} - {T}_{i}}{{T}_{max} - {T}_{min}} \cdot {w}_{e} , {w}_{c} )$$
where wₑ is a hyper-parameter that controls an overall weight of synthesizing data samples, Tₘₐₓ and Tₘᵢₙ are maximum and minimum values of T respectively, and w_{c} is a threshold value.

16. The computer-implemented method of claim 1, wherein the neural network based ranking model comprises:
a first model branch with a first multilayer perceptron and a first predictor operably coupled with the first multilayer perceptron;
a second model branch with a second multilayer perceptron and a second predictor operably coupled with the second multilayer perceptron; and
a combiner for combining an output of the first predictor and an output of the second predictor.

17. The computer-implemented method of claim 16, wherein the combiner is arranged to apply a weighting to the output of the first predictor and/or a weighting to the output of the second predictor.

18. The computer-implemented method of claim 16, wherein the training of the neural network based ranking model comprises:
performing a ranking or scoring operation based on the set of training data and the set of synthesized training data using the neural network based ranking model.

19. The computer-implemented method of claim 18, wherein the ranking or scoring operation comprises:
processing the set of training data with the first model branch; and
processing a combination of the set of training data and the set of synthesized training data with the second model branch.

20. The computer-implemented method of claim 19, further comprises:
determining ranking or scoring loss [symbol] based on the performing of the ranking or scoring operation.

21. The computer-implemented method of claim 18, wherein the training of the neural network based ranking model further comprises:
performing a contrastive learning operation based on the set of training data and/or the set of synthesized training data using the neural network based ranking model.

22. The computer-implemented method of claim 21, wherein the contrastive learning operation comprises:
for one or more of the queries: for data associated with each of the plurality of query-documents pairs of the query, performing a data perturbation operation to generate respective augmented data for the data of each of the plurality of query-documents pairs; and
processing the augmented data using the neural network based ranking model.

23. The computer-implemented method of claim 22, wherein the data perturbation operation comprises:
generating, for each of the data of each of the plurality of query-documents pairs:
a first set of augmented data with a first extent of noise injection; and
a second set of augmented data with a second extent of noise injection different from the first extent.

24. The computer-implemented method of claim 22,
wherein the neural network based ranking model further comprises:
a first projector operably coupled with the first multilayer perceptron; and
a second projector operably coupled with the second multilayer perceptron; and
wherein the contrastive learning operation further comprises:
processing the augmented data using the first multilayer perceptron and the first projector; and
processing the augmented data using the second multilayer perceptron and the second projector.

25. The computer-implemented method of claim 22, further comprises:
determining a contrastive loss [symbol] based on the performing of the contrastive learning operation.

26. The computer-implemented method of claim 22, further comprises:
performing a joint optimization operation based on the performing of the ranking or scoring operation and the performing of the contrastive learning operation.

27. The computer-implemented method of claim 26, wherein the joint optimization operation comprises:
jointly optimizing a ranking or scoring loss [symbol] associated with the performing of the ranking or scoring operation and the contrastive loss [symbol] associated with the performing of the contrastive learning operation.

28. The computer-implemented method of claim 27, wherein the jointly optimizing comprises: optimizing an overall loss [symbol] that equals to [symbol] +γ [symbol] , where γ is hyper-parameter.

29. A system for training a neural network based ranking model, comprising:
one or more processors; and
memory storing one or more programs configured to be executed by the one or more processors, the one or more programs including instructions for performing or facilitating performing of to the computer-implemented method of claim 1.

30. A computer-implemented method for operating the neural network based ranking model trained using the method of claim 1, comprising:
processing a query and a set of document data using the neural network based ranking model to determine a result.
